(19) United States
(12) Patent Application Publication
(10) Pub. No.: US 2007/0164996 A1
(43) Pub. Date: Jul. 19, 2007

(54) Joystick controller with centre-lock

(75) Inventor: Mark Gould, Hengoed (GB)

Correspondence Address: WELLS ST. JOHN P.S., 601 W. FIRST AVENUE, SUITE 1300, SPOKANE, WA, 99201, US

(73) Assignee: Penny & Giles Controls Limited

(21) Appl. No.: 11/651,893

(22) Filed: Jan. 9, 2007

(30) Foreign Application Priority Data
Jan. 12, 2006 (GB) 0600531.8

(51) Int. Cl. G09G 5/08

(52) U.S. Cl. 345/161

(57) ABSTRACT

A joystick controller comprises an operating shaft mounted for pivotal movement relative to a housing. The joystick controller is configured such that when the operating shaft is in a null position a release of pressure applied on the operating shaft is effective to lock the joystick so as to prevent further pivotal movement. Re-application of pressure on the operating shaft is effective to unlock the joystick.

This patent application claims priority from an earlier filed Great Britain Patent Application No. 00600531.8 filed Jan. 12, 2006, for “Joystick Controller with Centre-Lock”, by inventor Mark Gould.

The present invention relates to a joystick controller having a lock facility at a centre or null position.

Joystick controllers are used in a wide variety of motion control applications, for example where an operator is required to remotely control the manipulation or movement of a piece of equipment. It is known to provide a joystick with a locking facility so that an operating shaft of the joystick can be moved and locked in a predetermined position such that further movement of the operating shaft is prevented unless the lock is deliberately removed first. Such known joysticks require a positive action on the part of the operator to place the joystick into the locked condition. For example, this may require activating a separate clutch or lever, or else lifting the operating shaft to engage the lock. Lockable joysticks are particularly appropriate when the joystick is required to be left in a safe condition in which it cannot be inadvertently activated.

However, problems arise with joystick controllers that employ “return-to-centre” mechanisms where the operating shaft is spring-loaded to return to the centre, or to a null position, when released. In such cases, if the operator does not remember to activate the lock before leaving the equipment, the joystick will be left in an unsafe condition.

It is an object of the present invention to provide an improved joystick controller that alleviates the aforementioned problems.

According to a first aspect of the present invention there is provided a joystick controller comprising an operating shaft mounted for pivotal movement relative to a housing, wherein the joystick controller is configured such that when the operating shaft is in a null position a release of pressure applied on the operating shaft is effective to lock the joystick so as to prevent further pivotal movement, re-application of pressure on the operating shaft being effective to unlock the joystick.

In a preferred embodiment the Joystick controller further comprises means for returning the operating shaft to the null position when the operating shaft is released.

It is an advantage that operation of the joystick requires pressure to be applied by an operator to the operating shaft so as to unlock the joystick. Furthermore when the operator releases the pressure and the joystick is in the null position, it is immediately placed into a locked condition. This means that for a joystick provided with means for returning the operating shaft to a null position (e.g. a return to centre mechanism), whenever the operator releases the operating shaft it will return to the null position and become locked.

The joystick controller may be configured for pivotal movement in two directions (two degrees of freedom).

In embodiments of the invention, the joystick controller comprises a ball and socket arrangement. Preferably, the operating shaft is coupled to a ball member of the ball and socket arrangement. The ball member may comprise a part-spherical surface that cooperates with a corresponding bearing surface in a socket portion of the ball and socket arrangement. The socket portion may have a gate opening through which the operating shaft extends, the ball member having a non-spherical portion of a form that corresponds to the gate opening, whereby, when pressure is released from the operating shaft, the non-spherical portion of the ball member engages in the gate opening to lock the joystick.

In embodiments of the invention, the joystick may be configured such that when pressure is released from the operating shaft, it undergoes an axial movement to lock the joystick. Resilient biasing means may be provided to effect the axial movement; the resilient biasing means providing an axial biasing action between the operating shaft and the housing. In one embodiment, the resilient biasing means is a helical compression spring. The resilient biasing means may also comprise the means for returning the operating shaft to the null position when the operating shaft is released by providing a return biasing action against pivotal movement of the operating shaft when the operating shaft is moved away from the null position. The return biasing action may be provided by means of a slideable bush on the operating shaft in contact with a seat surface of the housing.

According to a second aspect of the present invention there is provided a joystick controller comprising an operating shaft coupled to a ball member of a ball-and-socket arrangement for effecting pivotal movement of the operating shaft relative to a socket member of the ball-and socket arrangement, the socket member being mounted in a housing, wherein the ball member comprises a part-spherical surface that cooperates with a bearing surface in the socket member, the socket member having a gate opening through which the operating shaft extends, the ball member having a non-spherical portion of a form that corresponds to the gate opening,

wherein means are provided for effecting axial movement of the operating shaft into a lock position, in which the non-spherical portion of the ball member enters the gate opening when in corresponding alignment therewith so as to prevent further pivotal movement of the operating shaft in the lock position.

The invention will now be described by way of example with reference to the following accompanying drawings.

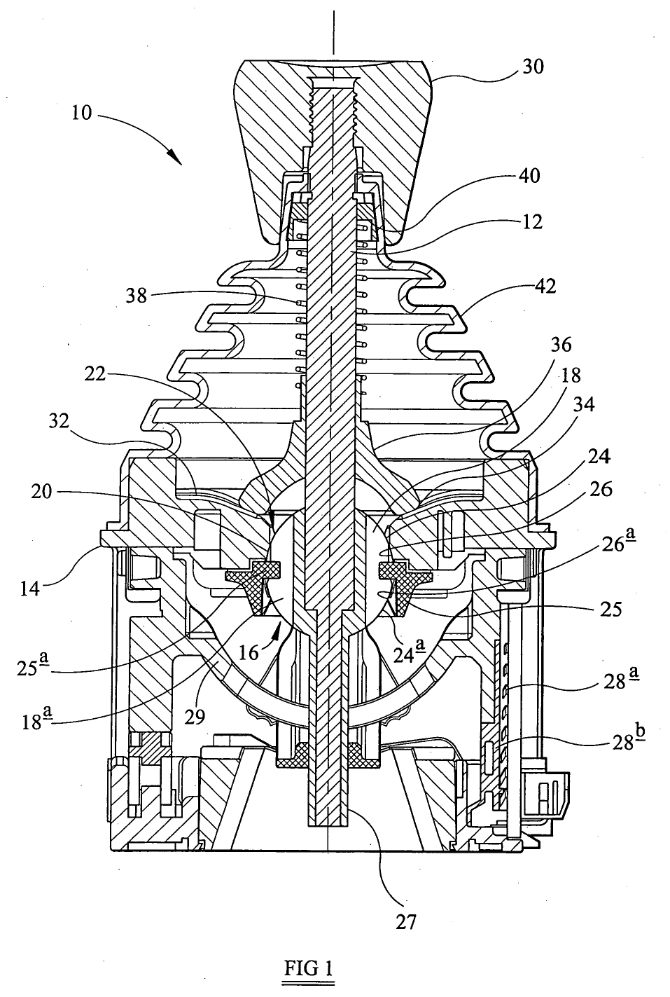

FIG. 1 is a cross-sectional arrangement through a joystick controller.

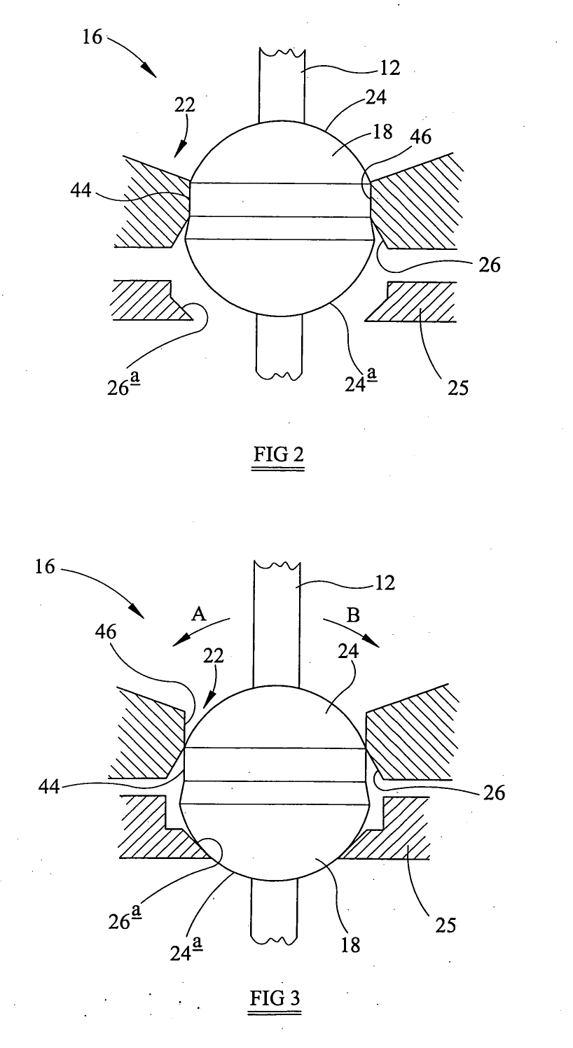

FIG. 2 shows a first position of a ball and socket arrangement of the joystick controller of FIG. 1, in a locked condition.

FIG. 3 shows a second position of a ball and socket arrangement of the joystick controller of FIG. 1, in an unlocked condition.

Referring to FIG. 1, a joystick controller 10 includes an operating shaft 12 mounted for pivotal movement relative to a housing 14. Pivotal movement is facilitated by means of a ball and socket arrangement 16 that includes a ball member 18 fixed to the operating shaft 12 and a socket portion 20 fixed to the housing 14. The ball member 18 has a part-spherical surface 24 and the socket portion 20 includes a bearing surface 26 against which the part-spherical surface 24 of the ball member 18 can slide when the operating shaft 12 is moved so as to pivot about a pivot centre defined by the centre of the part-spherical surface 24 when it bears against the bearing surface 26. The ball and socket arrangement 16 also includes a stop member 25, which provides a lower bearing surface 26a against which a lower part-spherical surface 24a of the ball member can slide. In the embodiment shown in FIG. 1 the stop member 25 has arms 25a, which engage in slots 18a in the ball member 18 and prevent rotation of the operating shaft 12 about its own axis.

The operating shaft 12 has an extension 27 beneath the ball and socket arrangement 16 (as shown in FIG. 1). Pivotal movement of the operating shaft causes displacement of a yoke 29, which is pivotally mounted to the body 14 on an axis that passes through the pivot centre of the ball and socket arrangement 16. Movement of the yoke 29 is detected by sensor elements in the form of a stator 28a and a wiper 28b of a potentiometer to provide an output signal for control purposes.

The socket portion 20 includes a gate opening 22. The operating shaft 12 extends through the gate opening 22 above the ball and socket arrangement 16 to an operating handle 30. The housing 14 includes a top surface 32 above the gate opening 22, which includes a seat surface 34 for a return-to centre mechanism that includes an annular bush 36, which is slideable up and down the operating shaft 12. The annular bush 36 is biased into contact with the seat surface 34 by a helical compression spring 38 mounted on the operating shaft 12 between the annular bush and an abutment surface 40 beneath the operating handle 30. A gaiter 42 surrounds the operating shaft and return-to-centre mechanism between the top surface 32 of the housing 14 and the operating handle 30 so as to protect the components from ingress of materials such as grits that could damage the components.

FIGS. 2 and 3 show a simplified view of the ball and socket arrangement 16, with extraneous components removed for clarity. In FIG. 2, the ball member 18 is fully engaged in the locked position within the gate opening 22. The gate opening 22 is a circular opening, having cylindrical side-walls 44. The part-spherical surface 24 of the ball member 18 forms the upper part of the ball member 18, beneath which is a cylindrical surface portion 46, sized to fit snugly within the gate opening 22. As a result, the cylindrical surface 44 of the gate opening 22 prevents pivotal movement of the ball member 18. In this position the lower part-spherical surface 24a of the ball member 18 is raised clear of the lower bearing surface 26a of the stop member 25.

Downward pressure on the operating handle 30 (see FIG. 1) causes the operating shaft 12 to move axially downwards compressing the compression spring 38. The ball member 18 moves downwards until it reaches the position shown in FIG. 3, where the lower part-spherical surface 24a of the ball member 18 abuts the lower bearing surface 26a of the stop member 25. At this position, the cylindrical surface 46 on the ball member 18 has moved below the cylindrical surface 44 of the gate opening 22. Now the part-spherical surface 24 of the ball member 18 is in alignment with the bearing surface 26 of the socket portion 20, such that the ball member 18 is free to rotate, and allowing pivotal movement of the operating shaft, as shown by the arrows A, B in FIG. 3.

It will be appreciated that, once the operating shaft has pivoted away from the vertical, the corresponding part-spherical surfaces 24, 24a of the ball member 18 and the socket portion 20 form a ball and socket joint that allows pivotal movement but does not allow any further axial movement of the operating shaft 12.

When the operating shaft 12 is tilted away from the central, vertical or null position shown, the annular bush 36 is also tilted relative to the housing 14 such that it only remains in contact with the seat surface 34 at one location (in line with the direction towards which the operating shaft 12 is tilted). As a result, the annular bush slides upwards on the operating shaft 12 to further compress the compression spring 38. The compressive force of the compression spring 38 acts through the point of contact between the annular bush 36 and the seat surface 34, which is out of alignment with the axis of the operating shaft 12 and the pivot centre of the ball and socket arrangement 16. This force provides a moment on the operating shaft 12 tending to return it to the centre, or null position. Consequently, when the operator releases the operating shaft 12 it returns to the central position. In that position the cylindrical surface 44 of the ball member 18 is aligned with the gate opening 22 and the force of the compression spring 38 raises the operating shaft axially so that the ball member enters the gate opening 22 back into the locked position as shown in FIG. 2.

1. A joystick controller comprising an operating shaft mounted for pivotal movement relative to a housing, wherein the joystick controller is configured such that when the operating shaft is in a null position a release of pressure applied on the operating shaft is effective to lock the joystick so as to prevent further pivotal movement, re-application of pressure on the operating shaft being effective to unlock the joystick.

2. A joystick controller according to claim 1, further comprising means for returning the operating shaft to the null position when the operating shaft is released.

3. The joystick controller of claim 1, configured for pivotal movement in two directions (two degrees of freedom).

4. The joystick controller of claim 1, comprising a ball and socket arrangement.

5. The joystick controller of claim 4, wherein the operating shaft is coupled to a ball member of the ball and socket arrangement.

6. The joystick controller of claim 5, wherein the ball member comprises a part-spherical surface that cooperates with a bearing surface in a socket portion of the ball and socket arrangement, the socket portion having a gate opening through which the operating shaft extends, the ball member having a non-spherical portion of a form that corresponds to the gate opening, whereby, when pressure is released from the operating shaft, the non-spherical portion of the ball member engages in the gate opening to lock the joystick.

7. The joystick controller of claim 1, configured such that when pressure is released from the operating shaft, it undergoes an axial movement to lock the joystick.

8. The joystick controller of claim 7 wherein resilient biasing means are provided to effect the axial movement, the resilient biasing means providing an axial biasing action between the operating shaft and the housing.

9. The joystick controller of claim 8, wherein the resilient biasing means is a helical compression spring.

10. The joystick controller of claim 7, wherein the resilient biasing means also comprises the means for returning the operating shaft to the null position when the operating shaft is released by providing a return biasing action against pivotal movement of the operating shaft when the operating shaft is moved away from the null position.

11. The joystick controller of claim 10, wherein the return biasing action is provided by means of a slideable bush on the operating shaft in contact with a seat surface of the housing.

12. A joystick controller comprising an operating shaft coupled to a ball member of a ball-and-socket arrangement for effecting pivotal movement of the operating shaft relative to a socket member of the ball-and socket arrangement, the socket member being mounted in a housing,
wherein the ball member comprises a part-spherical surface that cooperates with a bearing surface in the socket member, the socket member having a gate opening through which the operating shaft extends, the ball member having a non-spherical portion of a form that corresponds to the gate opening,
wherein means are provided for effecting axial movement of the operating shaft into a lock position, in which the non-spherical portion of the ball member enters the gate opening when in corresponding alignment therewith so as to prevent further pivotal movement of the operating shaft in the lock position.
